(19) United States
(12) Patent Application Publication
(10) Pub. No.: US 2014/0105306 A1
(43) Pub. Date: Apr. 17, 2014

(54) IMAGE PROCESSING APPARATUS AND IMAGE PROCESSING METHOD

(71) Applicant: CANON KABUSHIKI KAISHA, Tokyo (JP)

(72) Inventor: Satoshi Naito, Yokohama-shi (JP)

(73) Assignee: CANON KABUSHIKI KAISHA, Tokyo (JP)

(21) Appl. No.: 14/029,126

(22) Filed: Sep. 17, 2013

(30) Foreign Application Priority Data
Oct. 11, 2012 (JP) 2012-226331

(51) Int. Cl. H04N 7/36

(52) U.S. Cl. CPC H04N 19/00684
USPC 375/240.16

(57) ABSTRACT

Upon completion of storing the predictive residual data and predictive image of a block having undergone inter-frame coding in a predictive residual data memory and predictive image memory respectively, the block is decoded by performing motion compensation using the predictive residual data and the predictive image.

### BACKGROUND OF THE INVENTION

1. Field of the Invention

The present invention relates to a technique for decoding data encoded by inter-frame prediction encoding and, more particularly, to a technique for decoding encoded data by pipeline processing.

2. Description of the Related Art

As movie compression encoding methods for digital broadcasting, digital video, and the like, MPEG-2 and H.264 (ITU-T H.264 (March 2010) Advanced video coding for generic audiovisual services) (non-patent literature 1)) defined by ISO/IEC have been popularized. These movie compression methods adopt an inter-frame prediction encoding method of performing prediction encoding using the correlation between frames. In MPEG-2, a region having a high degree of correlation between frames is detected using a rectangular region called a macroblock as a unit, and the difference in spatial position between this region and a macroblock to be encoded is encoded as motion vector data. Further, the difference (predictive residual data) between the pixel value (predictive image data) of this region and that of the macroblock to be encoded is converted into coefficient data by DCDT or the like, and then is encoded. Note that motion vector data can indicate a position at non-integer precision. More specifically, an intermediate value between the pixels of regions having a high degree of correlation is generated by a filter, and prediction encoding processing is performed using the intermediate value as predictive image data.

In movie decoding processing, so-called motion compensation processing is performed to read out the image of a region indicated by motion vector data from a frame memory, generate a predictive image, and add it to predictive residual data. When motion vector data indicates a position at non-integer precision, image data to be used for a filter is also read out from the frame memory.

An example of a conventional movie decoding apparatus which implements this series of processes will be explained with reference to FIG. 10. The conventional movie decoding apparatus decodes a movie by pipeline processing which establishes synchronization between macroblocks.

An encoded data decoding unit 400 decodes input compression-encoded data, and outputs coefficient data and motion vector data. The encoded data decoding unit 400 executes the processing at pipeline stage 1.

An inverse quantization/inverse transformation unit 411 performs scan conversion to rearrange the coefficient data output from the encoded data decoding unit 400 in the order of inverse transformation calculation, then executes inverse quantization/inverse transformation, and outputs predictive residual data. The processing by the inverse quantization/inverse transformation unit 411 is executed at pipeline stage 2.

When a macroblock to be decoded has undergone intra-prediction encoding (intra-frame prediction encoding), an intra-prediction unit 413 decodes the macroblock by referring to decoded surrounding pixel values. The processing by the intra-prediction unit 413 is executed at pipeline stage 3.

Based on the motion vector data output from the encoded data decoding unit 400, a predictive image generation unit 421 reads out reference image data of a region indicated by motion vector data from decoded frames stored in a frame memory 440. The processing by the predictive image generation unit 421 is executed at pipeline stage 2.

A motion compensation unit 423 adds the predictive residual data and reference image data, and outputs decoded image data obtained by the addition to the intra-prediction unit 413 and a loop filter unit 430. The processing by the motion compensation unit 423 is executed at pipeline stage 3.

The loop filter unit 430 performs deblocking filter processing for the decoded image data. The image data having undergone deblocking filter processing is stored in a frame memory 440 because it is referred to by the predictive image generation unit 421 in subsequent frame decoding processing. The processing by the loop filter unit 430 is executed at pipeline stage 4.

A control unit 460 establishes synchronization between processes for each macroblock by the encoded data decoding unit 400, the inverse quantization/inverse transformation unit 411, the intra-prediction unit 413, the predictive image generation unit 421, the motion compensation unit 423, and the loop filter unit 430.

Recently, the number of pipeline stages in a memory controller for controlling the frame memory is increasing thanks to an increase in the operating frequency of the LSI. Along with this, the delay time from output of a readout address to the frame memory up to the start of transfer of corresponding data from the memory tends to be longer. In pipeline processing within the movie decoding apparatus, the processing time at a stage at which readout of a reference image and generation of a predictive image are performed increases, degrading the performance of the movie decoding apparatus. For example, the state of performance degradation will be explained with reference to the timing chart of FIG. 11 showing pipeline processing by the conventional movie decoding apparatus.

The processing executed by the predictive image generation unit 421 at stage 2 includes in detail output of the readout address of reference image data stored in the frame memory 440, reception of readout data, and generation of a predictive image. The processing time taken to complete generation of a predictive image is prolonged owing to the above-described long delay time from output of a readout address up to the start of data transfer from the memory. In the conventional movie decoding apparatus, the control unit 460 establishes synchronization between processes for each macroblock, so the long processing time at stage 2 degrades the performance of the movie decoding apparatus.

H.264 is capable of inter-frame prediction encoding using, as a unit, a rectangular region smaller than that in MPEG-2. For this reason, the readout data amount of reference image data increases, and the performance of the movie decoding apparatus may be further degraded. For example, readout data for progressive movie data is compared between MPEG-2 and H.264.

In MPEG-2, when inter-frame prediction decoding processing is performed using 16×16 pixels as a unit, if a motion vector at non-integer pixel precision is detected, data of 17×17 pixels=289 pixels are reads out from the frame memory which stores reference frames. To the contrary, in H.264, the minimum size of a rectangular region in inter-frame prediction decoding processing is 4×4 pixels. Since H.264 uses a 6-tap filter in order to generate predictive image data at non-integer prediction, a maximum of 9×9 pixels=81 pixels are read out for one 4×4-pixel region. In H.264, the maximum value of the readout pixel count in a macroblock of 16×16 pixels is 81 pixels×16=1296 pixels. In the worst case, data four times or more than that in MPEG-2 need to be read out.

As a technique for preventing an increase in the processing time at the pipeline stage in the movie decoding apparatus along with an increase in the delay time of frame memory readout and an increase in reference pixel count, International Publication No. 2008/114403 (patent literature 1) proposes a decoding method, decoder, and decoding apparatus. According to the technique in patent literature 1, a coefficient data storage unit and motion vector storage unit are arranged to store decoded coefficient data and motion vector data, respectively. This arrangement suppresses the performance degradation of the movie decoding apparatus arising from a delay accompanying readout of reference pixels for each macroblock.

However, the conventional technique has a problem that the memory of the coefficient data storage unit costs. For example, when the bit depth of the pixel sample of an original image is 8 bits, that of coefficient data is 16 bits per pixel sample. The size of a macroblock in H.264 is 16×16 pixels, and the number of pixel samples in the color difference 4:2:0 format is 16×16×1.5=384. Hence, when a buffer of four macroblocks is implemented, the conventional movie decoding apparatus requires a memory of 4×384×16=24,576 bits, raising the unit cost of the LSI which mounts the movie decoding apparatus.

### SUMMARY OF THE INVENTION

The present invention has been made to solve the above problems, and provides a technique for preventing degradation of the decoding processing performance, and implementing decoding processing at lower cost than that required by the conventional technique.

According to the first aspect of the present invention, an image processing apparatus which decodes each frame encoded for each block, comprising: a decoding unit configured to decode encoded data of each block, thereby generating coefficient data and motion vector data of the block; a unit configured to, every time the decoding unit generates coefficient data, generate predictive residual data from the coefficient data and store the predictive residual data in a predictive residual data memory capable of storing predictive residual data of at least two blocks; a predictive image generation unit configured to, every time the decoding unit generates motion vector data, read out an image of an image region indicated by the motion vector data from a decoded frame memory which stores a decoded frame, and store the readout image as a predictive image in a predictive image memory capable of storing predictive images of at least two blocks; and a motion compensation unit configured to, upon completion of storing predictive residual data and a predictive image of a block having undergone inter-frame coding in the predictive residual data memory and the predictive image memory respectively, decode the block by performing motion compensation using the predictive residual data and the predictive image, and store the decoded block in the decoded frame memory.

According to the second aspect of the present invention, an image processing apparatus which decodes each frame encoded for each block, comprising: a decoding unit configured to decode encoded data of each block, thereby generating two-dimensional coefficient data and motion vector data of the block; a unit configured to, every time the decoding unit generates two-dimensional coefficient data, perform first processing for the coefficient data as processing for each one-dimensional data string in one of a vertical direction and a horizontal direction, and store the coefficient data in a coefficient data memory capable of storing coefficient data of at least two blocks; a predictive image generation unit configured to, every time the decoding unit generates motion vector data, read out an image of an image region indicated by the motion vector data from a decoded frame memory which stores a decoded frame, and store the readout image as a predictive image in a predictive image memory capable of storing predictive images of at least two blocks; and a motion compensation unit configured to, upon completion of storing coefficient data of a block having undergone inter-frame coding in the coefficient data memory, generate predictive residual data by performing second processing for the coefficient data as processing for each one-dimensional data string in the other one of the vertical direction and the horizontal direction, decode the block by performing motion compensation using the predictive residual data and a predictive image of the block, and store the decoded block in the decoded frame memory.

According to the third aspect of the present invention, an image processing method to be performed by an image processing apparatus which decodes each frame encoded for each block, comprising: a decoding step of decoding encoded data of each block, thereby generating coefficient data and motion vector data of the block; a step of, every time coefficient data is generated in the decoding step, generating predictive residual data from the coefficient data and storing the predictive residual data in a predictive residual data memory capable of storing predictive residual data of at least two blocks; a predictive image generation step of, every time motion vector data is generated in the decoding step, reading out an image of an image region indicated by the motion vector data from a decoded frame memory which stores a decoded frame, and storing the readout image as a predictive image in a predictive image memory capable of storing predictive images of at least two blocks; and a motion compensation step of, upon completion of storing predictive residual data and a predictive image of a block having undergone inter-frame coding in the predictive residual data memory and the predictive image memory respectively, decoding the block by performing motion compensation using the predictive residual data and the predictive image, and storing the decoded block in the decoded frame memory.

According to the fourth aspect of the present invention, an image processing method to be performed by an image processing apparatus which decodes each frame encoded for each block, comprising: a decoding step of decoding encoded data of each block, thereby generating two-dimensional coefficient data and motion vector data of the block; a step of, every time two-dimensional coefficient data is generated in the decoding step, performing first processing for the coefficient data as processing for each one-dimensional data string in one of a vertical direction and a horizontal direction, and storing the coefficient data in a coefficient data memory capable of storing coefficient data of at least two blocks; a predictive image generation step of, every time motion vector data is generated in the decoding step, reading out an image of an image region indicated by the motion vector data from a decoded frame memory which stores a decoded frame, and storing the readout image as a predictive image in a predictive image memory capable of storing predictive images of at least two blocks; and a motion compensation step of, upon completion of storing coefficient data of a block having undergone inter-frame coding in the coefficient data memory, generating predictive residual data by performing second processing for the coefficient data as processing for each one-dimensional data string in the other one of the vertical direction and the horizontal direction, decoding the block by performing motion compensation using the predictive residual data and a predictive image of the block, and storing the decoded block in the decoded frame memory.

Further features of the present invention will become apparent from the following description of exemplary embodiments with reference to the attached drawings.

### BRIEF DESCRIPTION OF THE DRAWINGS

FIG. 1 is a block diagram exemplifying the functional arrangement of an image processing apparatus;

FIG. 2 is a block diagram exemplifying the arrangement of a predictive image generation unit 121;

FIG. 3 is a timing chart;

FIG. 4 is a block diagram exemplifying the functional arrangement of an image processing apparatus;

FIG. 5 is a timing chart;

FIG. 6 is a block diagram showing the detailed arrangement of a predictive image generation unit 121;

FIG. 7 is a view for explaining a predictive image generated using a filter;

FIG. 8 is a block diagram exemplifying the functional arrangement of an image processing apparatus;

FIG. 9 is a timing chart;

FIG. 10 is a block diagram exemplifying a conventional movie decoding apparatus; and

FIG. 11 is a timing chart.

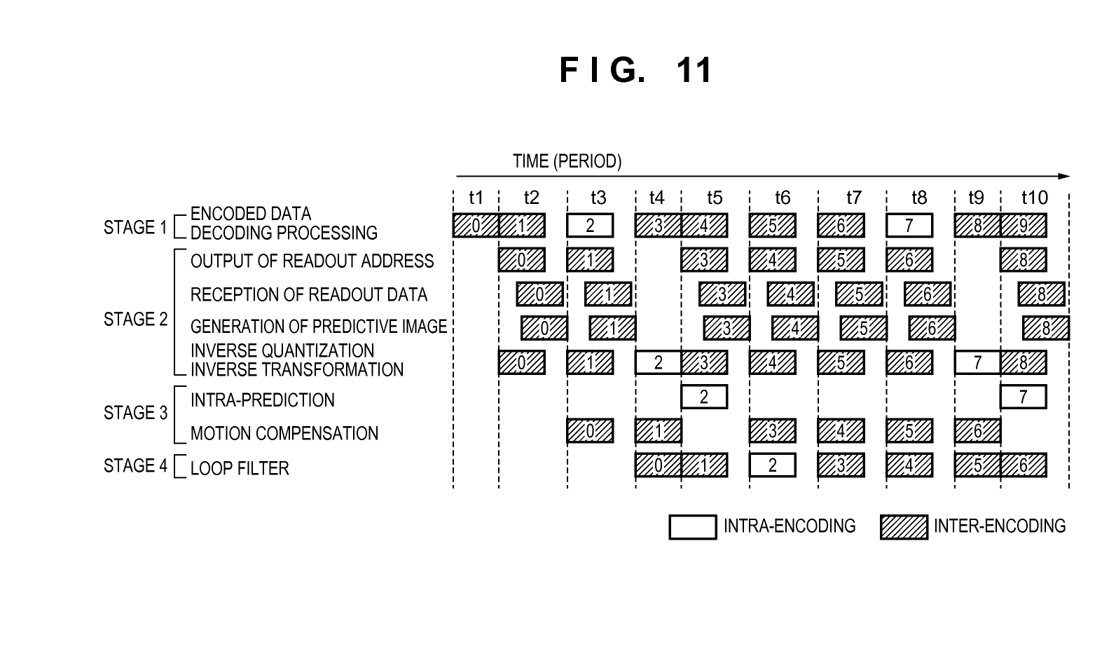

### DESCRIPTION OF THE EMBODIMENTS

Embodiments of the present invention will now be described with reference to the accompanying drawings. The embodiments to be described below are examples when the present invention is practiced concretely, and are detailed embodiments of arrangements described in the appended claims.

### First Embodiment

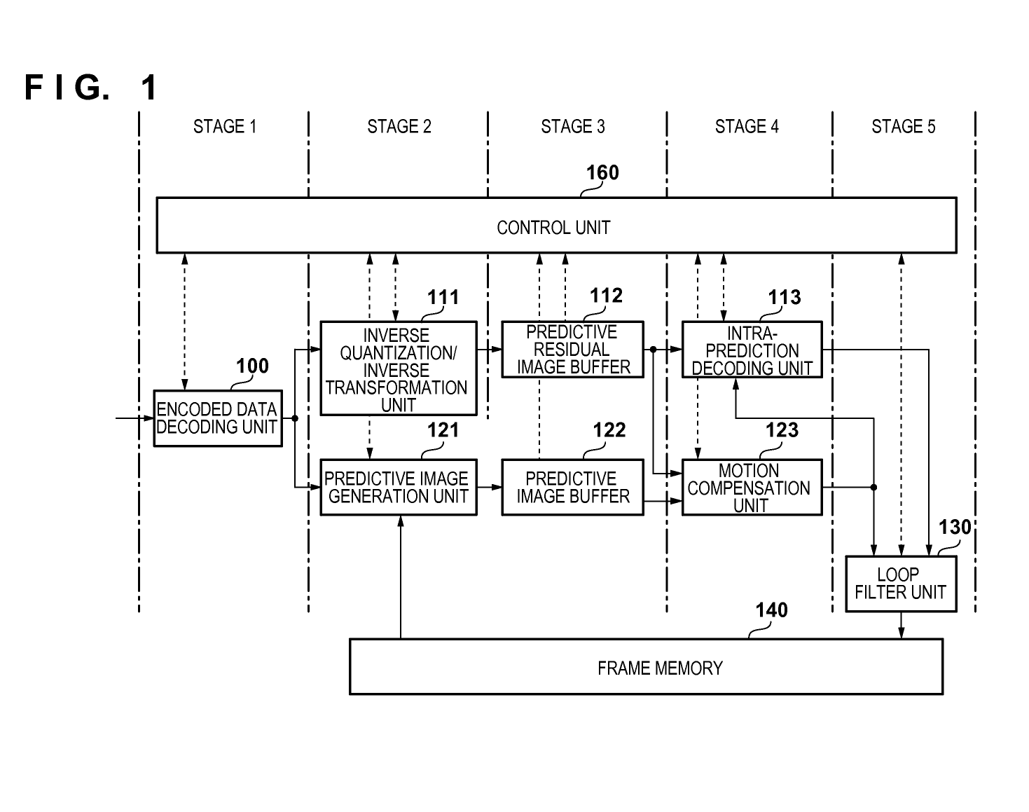

An example of the functional arrangement of an image processing apparatus which decodes encoded data of each frame encoded for each macroblock will be explained with reference to the block diagram of FIG. 1. In the first embodiment, pipeline processing is performed using a rectangular region of 16×16 pixels, called a macroblock, as a unit according to the H.264 encoding method. However, this is merely an example of concretely implementing the description. For example, in an encoding method using a rectangular region larger than 16×16 pixels as a processing unit, pipeline processing may be carried out using this rectangular region as a unit.

An encoded data decoding unit 100 decodes encoded data input for each macroblock according to CABAC (Context-Adaptive Binary Arithmetic Coding) or CAVLC (Context-Adaptive Variable Length Coding) in H.264. Note that the decoding method complies with the encoding method and is not limited to one described here. For example, in MPEG-2, encoded data is decoded based on a variable-length encoding method.

The encoded data decoding unit 100 generates coefficient data and motion vector data for each macroblock by this decoding. The encoded data decoding unit 100 outputs the coefficient data to an inverse quantization/inverse transformation unit 111, and the motion vector data to a predictive image generation unit 121.

Upon receiving the coefficient data output from the encoded data decoding unit 100 for each macroblock, the inverse quantization/inverse transformation unit 111 performs scan conversion to rearrange the coefficient data in the order of inverse transformation calculation, then executes inverse quantization/inverse transformation, and outputs predictive residual data. The series of processes up to generation of predictive residual data from coefficient data is a known technique, and a detailed description of this technique will be omitted. The inverse quantization/inverse transformation unit 111 stores the generated predictive residual data in a predictive residual image buffer 112 at a subsequent stage. The predictive residual image buffer 112 is a predictive residual data memory capable of storing predictive residual data of at least two macroblocks.

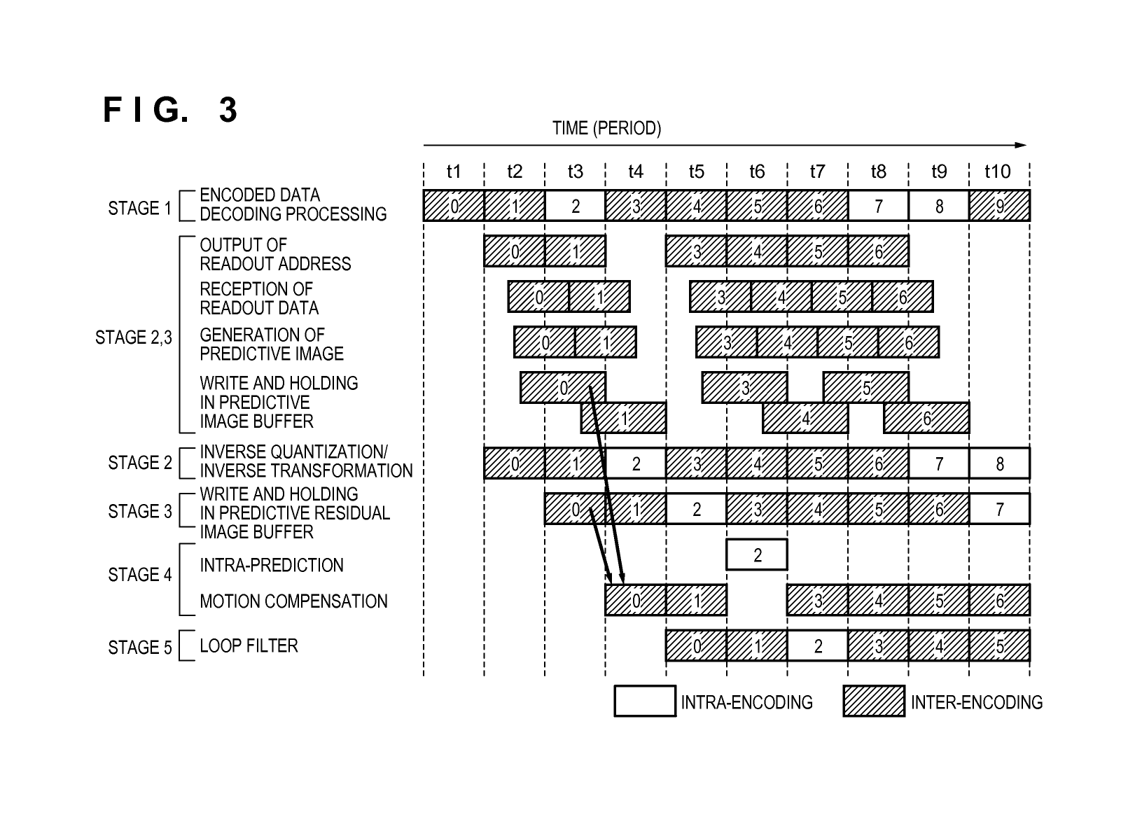

When a macroblock to be decoded has undergone intra-prediction encoding (intra-frame prediction encoding) at stage 4 (FIG. 3), an intra-prediction decoding unit 113 refers to decoded surrounding pixel values in accordance with an instruction from a control unit 160. Then, the intra-prediction decoding unit 113 decodes the macroblock by using predictive residual data of the macroblock stored in the predictive residual image buffer 112 and the referred surrounding pixel values. Note that the intra-prediction decoding unit 113 includes a line buffer (not shown) and stores, in the line buffer, the pixel values of surrounding pixels to be referred to when performing intra-prediction decoding for a subsequent macroblock.

Upon receiving the motion vector data output from the encoded data decoding unit 100 for each macroblock, the predictive image generation unit 121 reads out, as a reference image, the image of an image region indicated by the motion vector data from a frame memory 140 which stores decoded frames. When the motion vector data indicates a non-integer position, the predictive image generation unit 121 generates a predictive image by interpolating a reference image by using a filter. In other cases, the predictive image generation unit 121 uses, as a predictive image, a reference image read out from the frame memory 140. The predictive image generation unit 121 stores the obtained predictive image in a predictive image buffer 122 at a subsequent stage. The predictive image buffer 122 is a predictive image memory capable of storing predictive images of at least two macroblocks.

A motion compensation unit 123 reads out predictive residual data and a predictive image from the predictive residual image buffer 112 and predictive image buffer 122, respectively, in accordance with an instruction from the control unit 160, and adds them, thereby generating the decoded image of a macroblock. The motion compensation unit 123 outputs the generated decoded image to the intra-prediction decoding unit 113 and a loop filter unit 130.

To establish synchronization between the pipeline processes of the respective processing units in FIG. 1, the control unit 160 instructs the start of the next macroblock processing after detecting the end of macroblock processes by the respective processing units except for the predictive image generation unit 121. When a macroblock to be decoded at corresponding stage 4 (FIG. 3) has undergone inter-prediction encoding (inter-frame prediction encoding), the control unit 160 instructs the motion compensation unit 123 to start the operation. When a macroblock to be decoded has undergone intra-prediction encoding, the control unit 160 instructs the intra-prediction decoding unit 113 to start the operation.

The loop filter unit 130 performs deblocking filter processing defined by the H.264 encoding method for a decoded image sent from the motion compensation unit 123 or intra-prediction decoding unit 113. The loop filter unit 130 stores the decoded image having undergone deblocking filter processing in the frame memory 140 so that the predictive image generation unit 121 refers to it in decoding processing for a subsequent frame.

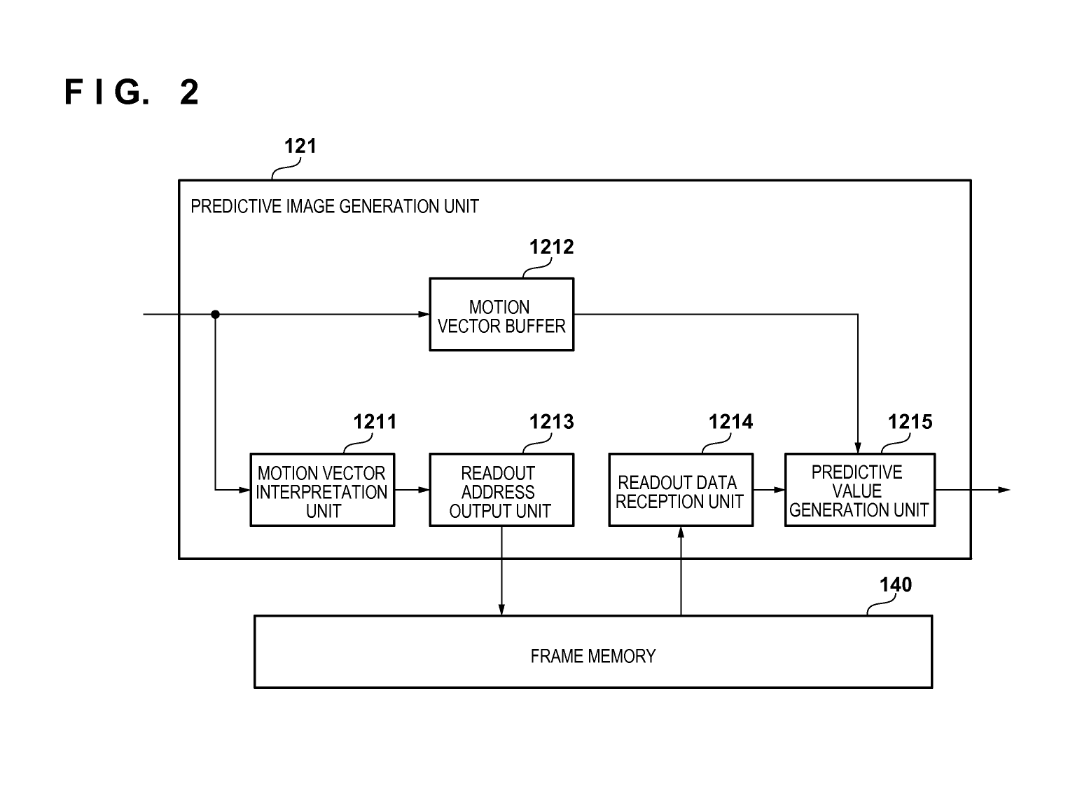

Next, an example of the arrangement of the predictive image generation unit 121 will be described with reference to the block diagram of FIG. 2. Motion vector data input to the predictive image generation unit 121 is input to a motion vector buffer 1212 and motion vector interpretation unit 1211.

The motion vector interpretation unit 1211 calculates, from motion vector data, an address in the frame memory 140 at which an image in an image region indicated by the motion vector data is stored.

The motion vector buffer 1212 is a memory capable of storing motion vector data of at least two macroblocks. Motion vector data is stored in the motion vector buffer 1212 to use it for generation of a predictive image by interpolation using a filter.

A readout address output unit 1213 outputs the address obtained by the motion vector interpretation unit 1211 as an image readout address to the frame memory 140. The readout address output unit 1213 includes a FIFO (not shown) and buffers, in the FIFO, the address output from the motion vector interpretation unit 1211.

The frame memory 140 includes a memory controller and DRAM (neither is shown). The memory controller further includes a FIFO, and stores a predetermined number of readout addresses in the FIFO. If the FIFO in the memory controller becomes full, a readout address is stored in the FIFO in the readout address output unit 1213. During the delay time till readout of image data from the DRAM, the memory controller can store a plurality of addresses output from the readout address output unit 1213 prior to the readout data.

A readout data reception unit 1214 reads out data stored in a storage area in the frame memory 140 (DRAM) that is designated by a readout address, that is, a reference image. The readout data reception unit 1214 outputs the readout reference image to a predictive value generation unit 1215 at a subsequent stage.

The predictive value generation unit 1215 generates a predictive image by using the motion vector data stored in the motion vector buffer 1212 and the reference image received from the readout data reception unit 1214. If the motion vector data indicates the position of a non-integer pixel, the predictive value generation unit 1215 generates predictive image data by using a filter. The calculation equation for the filter is known from non-patent literature 1, and a description thereof will be omitted.

Next, a state in which the image processing apparatus performs pipeline processing for each macroblock will be explained with reference to FIGS. 1 to 3. In the embodiment, the pipeline stage is divided into five. Encoded data decoding processing by the encoded data decoding unit 100 is executed at stage 1. Processing by the inverse quantization/inverse transformation unit 111 is executed at stage 2. Write of data in the predictive residual image buffer 112 is executed at stage 3. Processing by the intra-prediction decoding unit 113 is executed at stage 4. Processing by the loop filter unit 130 is executed at stage 5. Processing by the predictive image generation unit 121 and write of data in the predictive image buffer 122 are executed from stage 2 to stage 3. Processing by the motion compensation unit 123 is executed at stage 4. Note that the relationship between the respective processing units and the stages is not limited to this. For example, each stage may be subdivided.

Attention is paid to macroblock 0 in FIG. 3, and a sequence until encoded data of macroblock 0 is decoded will be explained. The same description can apply to another macroblock as long as the macroblock has undergone inter-frame encoding.

When encoded data of macroblock 0 is input to the encoded data decoding unit 100, the encoded data decoding unit 100 decodes the encoded data in period t1, generating coefficient data and motion vector data.

In period t2, the motion vector interpretation unit 1211 obtains the address of an image region indicated by the motion vector data of macroblock 0. The readout address output unit 1213 outputs the address to the frame memory 140.

From period t2 to period t3, the readout data reception unit 1214 sequentially reads out reference image data from the frame memory 140, and sequentially sends the readout data to the predictive value generation unit 1215. Upon receiving the data from the readout data reception unit 1214, the predictive value generation unit 1215 generates a predictive image based on this data in the above-described manner, and stores it in the predictive image buffer 122 sequentially from the generated portions. The operation of the predictive value generation unit 1215 is performed from period t2 to period t3.

The inverse quantization/inverse transformation unit 111 obtains predictive residual data from the coefficient data of macroblock 0 in period t2, and stores it in the predictive residual image buffer 112 in period t3.

In other words, the storage of the predictive residual data and predictive image of macroblock 0 is completed at the end of period t3. In response to this, the control unit 160 instructs the start of the next pipeline processing. This instruction includes an instruction to the motion compensation unit 123 to start readout of data from the predictive residual image buffer 112 and predictive image buffer 122. In period t4, the motion compensation unit 123 generates a decoded image of macroblock 0 by using the predictive residual data and predictive image of macroblock 0.

In period t5, the loop filter unit 130 performs deblocking filter processing for the decoded image of macroblock 0, and stores the decoded image having undergone deblocking filter processing in the frame memory 140.

Macroblock 2 is a macroblock having undergone intra-prediction encoding (intra-frame prediction encoding). When encoded data of macroblock 2 is input to the encoded data decoding unit 100, the encoded data decoding unit 100 decodes the encoded data in period t3, generating coefficient data. The inverse quantization/inverse transformation unit 111 obtains predictive residual data from the coefficient data of macroblock 2 in period t4, and stores it in the predictive residual image buffer 112 in period t5. Since the storage of the predictive residual data of macroblock 2 is completed at the end of period t5, the control unit 160 instructs the start of the next pipeline processing. This instruction includes an instruction to the intra-prediction decoding unit 113 to start readout of data from the predictive residual image buffer 112. In period t6, the intra-prediction decoding unit 113 generates a decoded image of macroblock 2 by using the predictive residual data of macroblock 2. In period t7, the loop filter unit 130 performs deblocking filter processing for the decoded image of macroblock 2, and stores the decoded image having undergone deblocking filter processing in the frame memory 140.

In this way, according to the first embodiment, the series of processes from output of a readout address up to write in the predictive image buffer is executed through two pipeline stages. Even if the delay time is generated from output of a readout address up to reception of readout data, degradation of the processing performance of the image processing apparatus can be prevented.

<Modification>

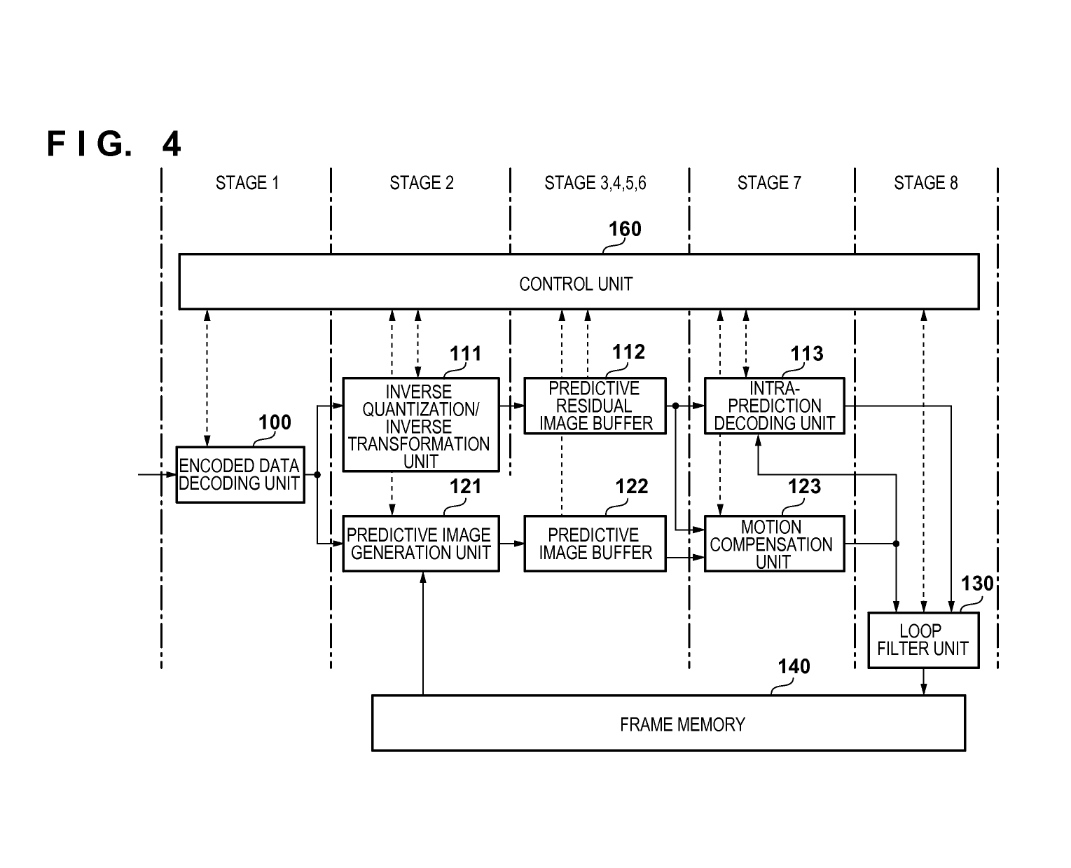

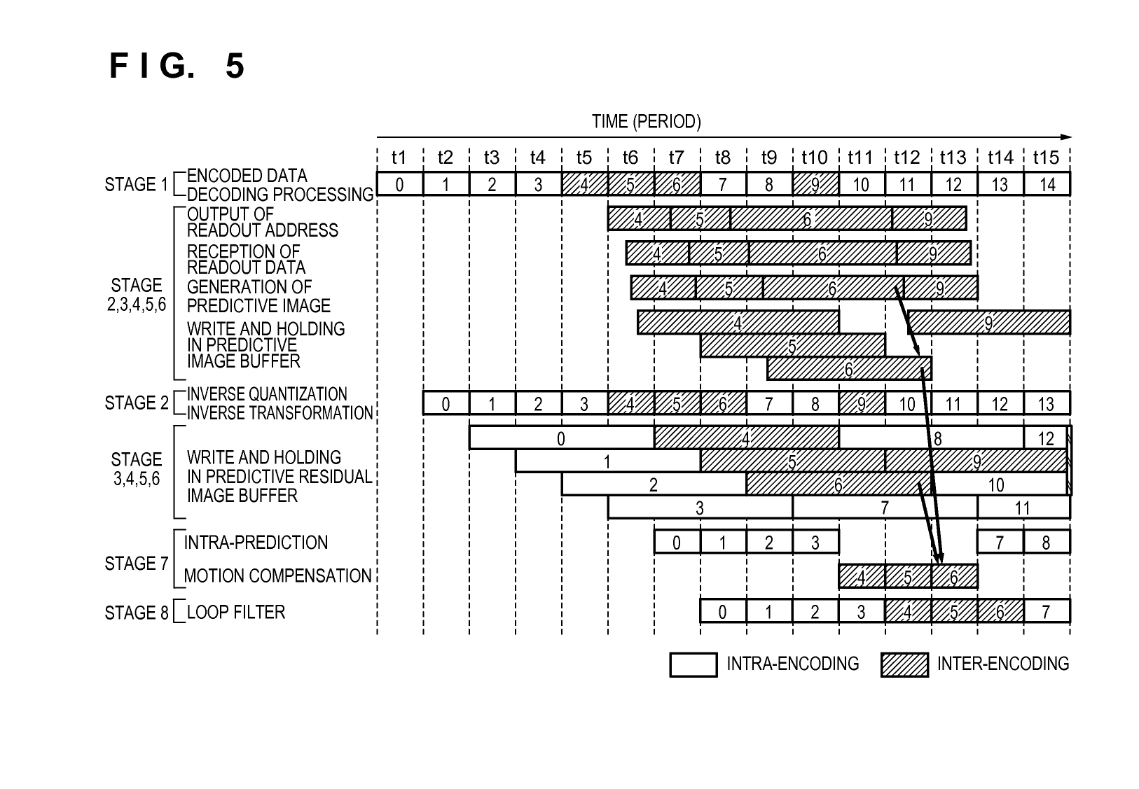

The present invention can cope with not only an increase in delay time from output of a readout address up to reception of data, but also an increase in readout data reception time due to an increase in reference image to be read out, similar to patent literature 1. This modification will be explained with reference to FIG. 4 which is a block diagram showing an example of the functional arrangement of the image processing apparatus when the pipeline stage is subdivided, and FIG. 5 which is a timing chart.

The arrangement shown in FIG. 4 is the same as that shown in FIG. 1 except that the pipeline stage is divided into eight, and the correspondence between stage 3 and subsequent stages, and processing units is slightly different. More specifically, processing by the predictive image generation unit 121, write of data in the predictive image buffer 122, and holding of data are executed from stage 2 to stage 6. Also, write of data in the predictive residual image buffer 112 and holding of data are executed at stage 3 to stage 6. Along with them, processing by the intra-prediction decoding unit 113 and processing by the motion compensation unit 123 are executed at stage 7, and processing by the loop filter unit 130 is executed at stage 8. Each of the predictive image buffer 122 and predictive residual image buffer 112 includes a buffer for holding data of four macroblocks. Further, in the modification, the readout address output unit 1213 in FIG. 2 incorporates a FIFO (not shown) for holding the addresses of four macroblocks.

Attention is paid to macroblock 6 in the timing chart of FIG. 5. Since many reference images are read out from the frame memory 140 for macroblock 6, the series of processes from output of a readout address up to generation of a predictive image is executed from times t8 to t12. That is, the series of processes takes a processing time for five stages. In contrast, predictive residual data of macroblock 6 having undergone inverse quantization/inverse transformation at stage 2 (period t8) is stored in the predictive residual image buffer 112 at stage 3 to stage 6 (period t9 to period t12). After that, motion compensation processing for macroblock 6 is performed at stage 7 (period t13). Since subsequent macroblock 7 is a macroblock having undergone intra-prediction encoding, the series of processes from output of a readout address up to generation of a predictive image is not executed, and the delay time generated by the processing of macroblock 6 can be absorbed. Hence, even if the series of processes from output of a readout address up to generation of a predictive image increases, the processing time per stage of pipeline processing does not increase, and movie data can be decoded with stable performance.

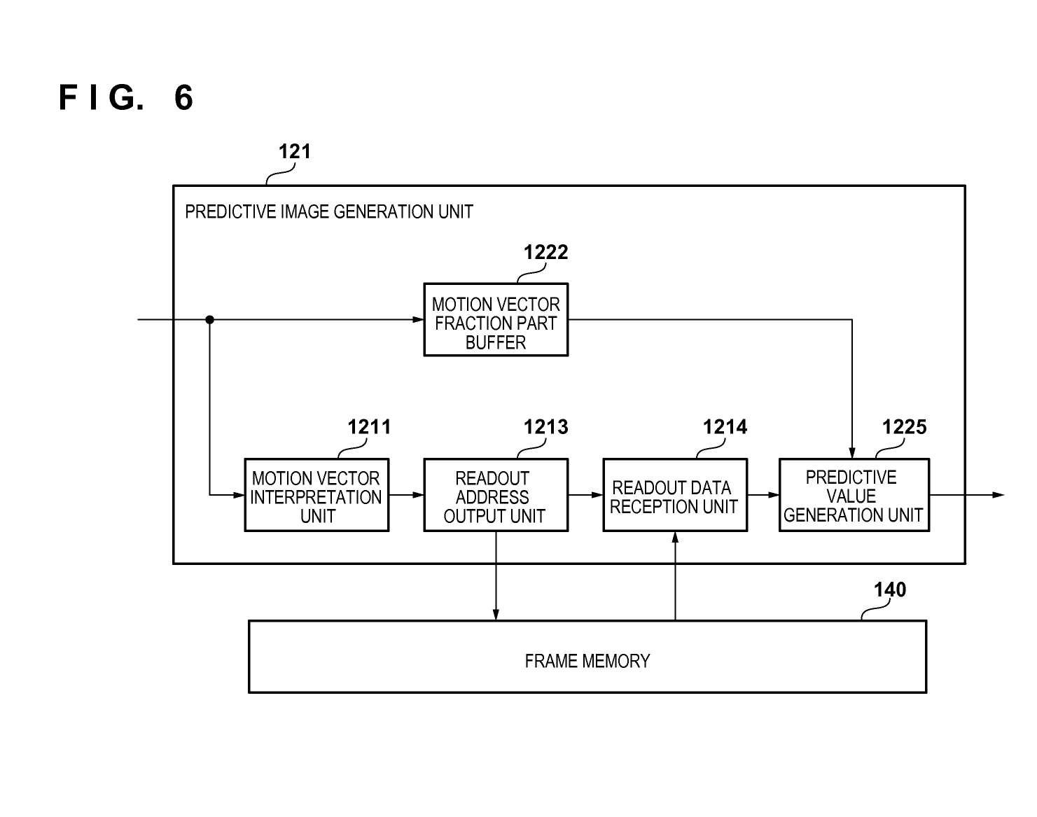

Unlike the conventional technique described in patent literature 1, not decoded coefficient data but predictive residual data as an output from inverse transformation processing is held in the buffer, so the buffer capacity can be reduced. For example, referring to FIG. 6 of patent literature 1, coefficient data of macroblocks 1 to 4 are stored in a coefficient data storage unit when performing coefficient data interpretation, inverse quantization, and inverse frequency transformation for macroblock 0. To achieve this, a buffer of four macroblocks is needed. The size of a macroblock in H.264 is 16×16 pixels, and the number of samples in the color difference 4:2:0 format is 16×16×1.5=384 samples. When the bit depth of an original image is 8 bits, that of coefficient data is 16 bits per sample. The conventional movie decoding apparatus therefore requires a buffer of 4×384×16=24,576 bits. To the contrary, predictive residual data to be held in the buffer is 9 bits per sample though the modification requires buffer stages for four macroblocks, which is the same as in the conventional technique. In the modification, a buffer of 4×384×9=13,824 bits suffices, and the cost can be reduced much more than in the conventional technique.

Note that the first embodiment and its modification target the H.264 encoding method, but are not limited to it. For example, the first embodiment and its modification are also applicable to the MPEG-2 encoding method. In this case, the intra-prediction decoding unit 113 and loop filter unit 130 are excluded from the block diagram of FIG. 1. In addition, the number of blocks held by each of the predictive image buffer 122 and predictive residual image buffer 112 is not limited to the above-described one, and is arbitrarily two or more.

The first embodiment and its modification are merely examples of the following basic arrangement, and any arrangement may be employed as long as it is equivalent to this basic arrangement. In this basic arrangement, encoded data of each block is decoded to generate coefficient data and motion vector data of the block. Every time coefficient data is generated, predictive residual data is generated from the coefficient data, and stored in a predictive residual data memory capable of storing predictive residual data of at least two blocks. Further, every time motion vector data is generated, the image of an image region indicated by the motion vector data is read out from a decoded frame memory which stores decoded frames. The readout image is stored as a predictive image in a predictive image memory capable of storing predictive images of at least two blocks (generation of a predictive image).

Upon completion of storing the predictive residual data and predictive image of a block having undergone inter-frame encoding in the predictive residual data memory and predictive image memory, the block is decoded by performing motion compensation using the predictive residual data and predictive image. The decoded block is then stored in the decoded frame memory.

### Second Embodiment

An image processing apparatus according to the second embodiment has the same arrangement as that of the first embodiment, but only the arrangement of a predictive image generation unit 121 is different from that in the first embodiment. The detailed arrangement of the predictive image generation unit 121 according to the second embodiment will be explained with reference to the block diagram of FIG. 6. In FIG. 6, the same reference numerals as those in FIG. 2 denote the same processing units, and a description of these processing units will not be repeated.

A motion vector fraction part buffer 1222 is a memory for storing only the fraction part of motion vector data which is output from an encoded data decoding unit 100 and made up of an integer part and fraction part.

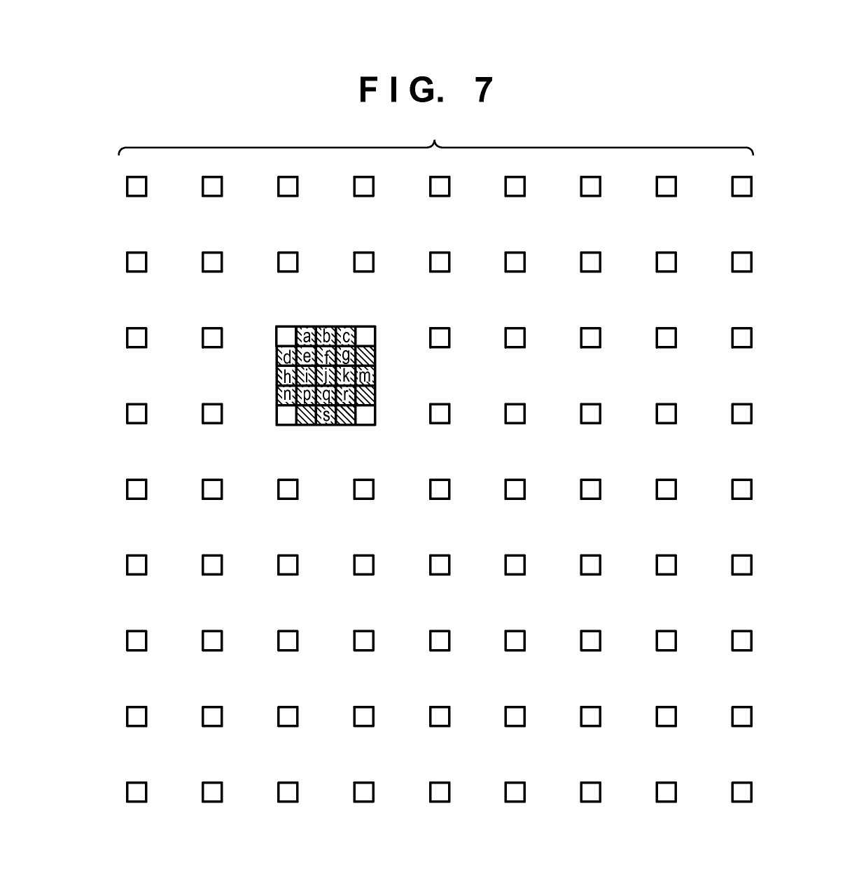

A predictive image generated by a predictive value generation unit 1225 using a filter will be described with reference to FIG. 7. In FIG. 7, a blank rectangle represents a pixel at an integer position (integer coordinate position). A hatched rectangle represents a pixel (pixel at a non-integer position) generated by interpolating pixels at integer positions using a filter. To avoid a complicated drawing, only some pixels at non-integer positions are illustrated. In the H.264 encoding method, pixels (b, h, j, q, m, and s in FIG. 7) positioned at +0.5 along the ordinate or abscissa are generated using a 6-tap filter (the calculation equation for the filter is known from non-patent literature 1, and a description thereof will be omitted). The remaining pixels are generated by obtaining the average values of pixels at integer positions or pixels positioned at +0.5 along the ordinate or abscissa.

In this fashion, the method of generating a pixel at a non-integer position is determined by a pixel position indicated by the fraction part of motion vector data. The predictive value generation unit 1225 can generate a predictive image by referring to only the fraction part of motion vector data. The motion vector fraction part buffer 1222 suffices to store only the fraction part of motion vector data output from the encoded data decoding unit 100. Since the buffer for storing motion vector data can be smaller than a conventional one, the second embodiment can reduce the cost.

### Third Embodiment

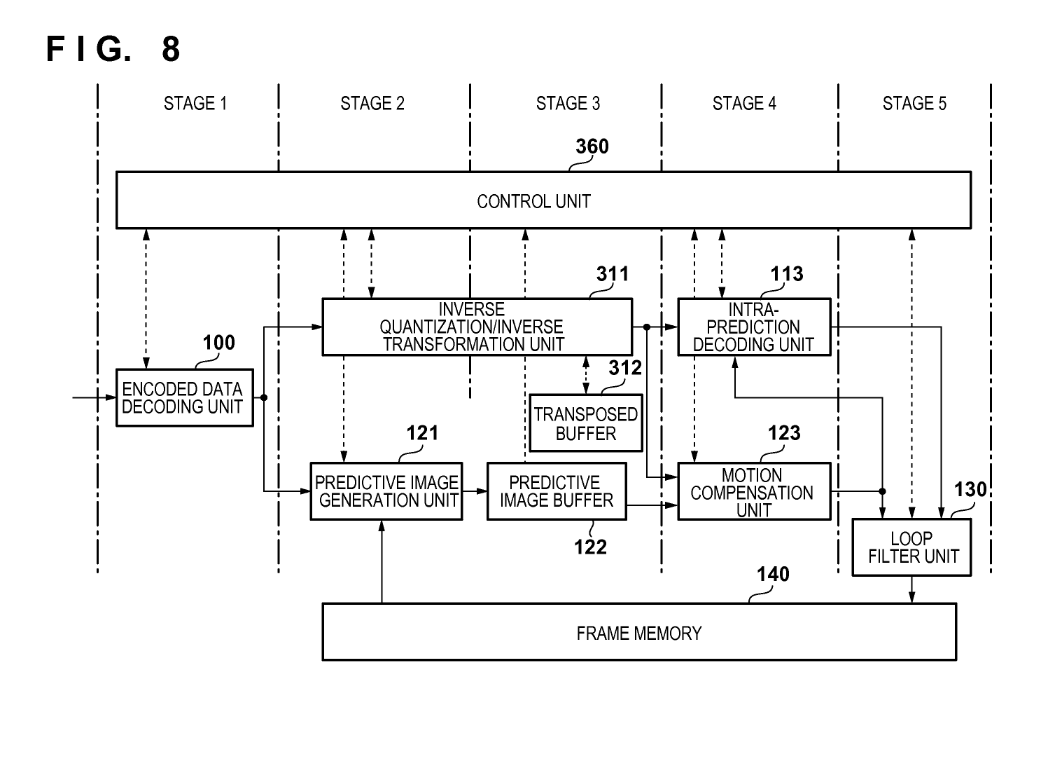

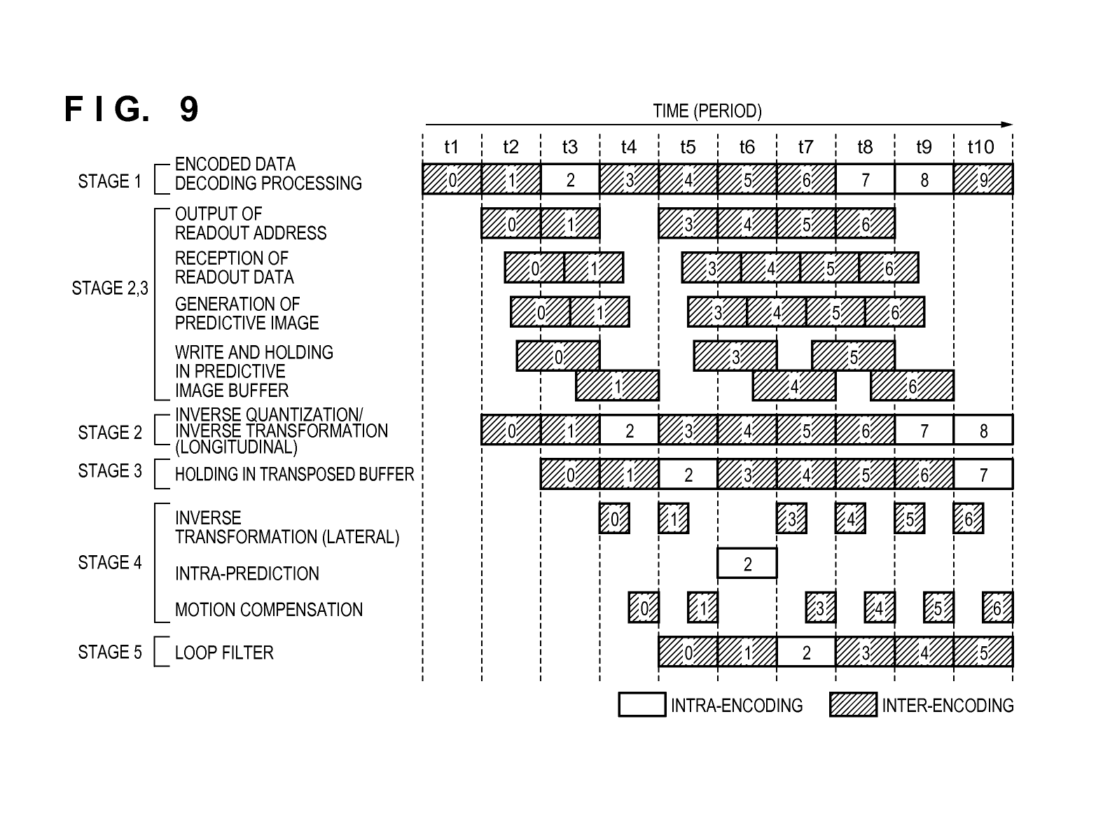

An example of the functional arrangement of an image processing apparatus according to the third embodiment will be explained with reference to the block diagram of FIG. 8. In FIG. 8, the same reference numerals as those in FIG. 1 denote the same processing units, and a description of these processing units will not be repeated. FIG. 9 is a timing chart showing processing by the image processing apparatus according to the third embodiment.

An inverse quantization/inverse transformation unit 311 performs inverse quantization/inverse transformation processing from stage 2 to stage 4, and outputs predictive residual data. A transposed buffer 312 is a coefficient data memory which stores coefficient data during transformation in inverse transformation processing, and is a memory capable of storing coefficient data during transformation of at least two macroblocks.

Generally in encoding and decoding of a movie, transformation processing is implemented by executing one-dimensional transformation or inverse transformation twice in total in the longitudinal and lateral directions for a two-dimensional image. Also in the third embodiment, inverse quantization processing is performed at stage 2, and the first one-dimensional inverse transformation is performed for the inversely quantized transformation coefficient. At stage 3, the coefficient data having undergone the first inverse transformation is stored in the transposed buffer 312. At stage 4, the second one-dimensional inverse transformation is performed for the coefficient data stored in the transposed buffer 312 in accordance with an instruction from a control unit 360. Note that motion compensation processing and the second inverse transformation are sequentially performed at stage 4. However, the series of processes is considered not to bottleneck pipeline processing because motion compensation only adds predictive residual data and predictive image data.

The control unit 360 detects the end of the first one-dimensional transformation by the inverse quantization/inverse transformation unit 311, and processes by an encoded data decoding unit 100, intra-prediction decoding unit 113, motion compensation unit 123, loop filter unit 130, and predictive image buffer 122. After detecting the end, the control unit 360 instructs the respective units to start processes for the next macroblock.

Similar to the first embodiment, processing by a predictive image generation unit 121 is completed at stage 3 under the influence of a delay of readout of data from a frame memory 140. However, the transposed buffer 312 can absorb this delay. In the third embodiment, a buffer for absorbing a delay of readout from the frame memory can also be implemented by the transposed buffer used for inverse transformation processing, reducing the cost much more than in the conventional technique. Note that the predictive image generation unit 121 can also be configured to store only the fraction part of motion vector data, similar to the second embodiment. The above-described embodiments and the modification can be combined and used appropriately.

The third embodiment is merely an example of the following basic arrangement, and any arrangement may be adopted as long as it is equivalent to this basic arrangement. In this basic arrangement, encoded data of each block is decoded to generate two-dimensional coefficient data and motion vector data of the block. Every time two-dimensional coefficient data is generated, the coefficient data undergoes the first processing as processing for a one-dimensional data string in one of the vertical and horizontal directions, and then is stored in a coefficient data memory capable of storing coefficient data of at least two blocks. Also, every time motion vector data is generated, the image of an image region indicated by the motion vector data is read out from a decoded frame memory which stores decoded frames. The readout image is stored as a predictive image in a predictive image memory capable of storing predictive images of at least two blocks.

Upon completion of storing coefficient data of a block having undergone inter-frame encoding in the coefficient data memory, predictive residual data is generated by performing the second processing for the coefficient data as processing for a one-dimensional data string in the other one of the vertical and horizontal directions. The block is decoded by performing motion compensation using the predictive residual data and the predictive image of the block. The decoded block is then stored in the decoded frame memory.

### Fourth Embodiment

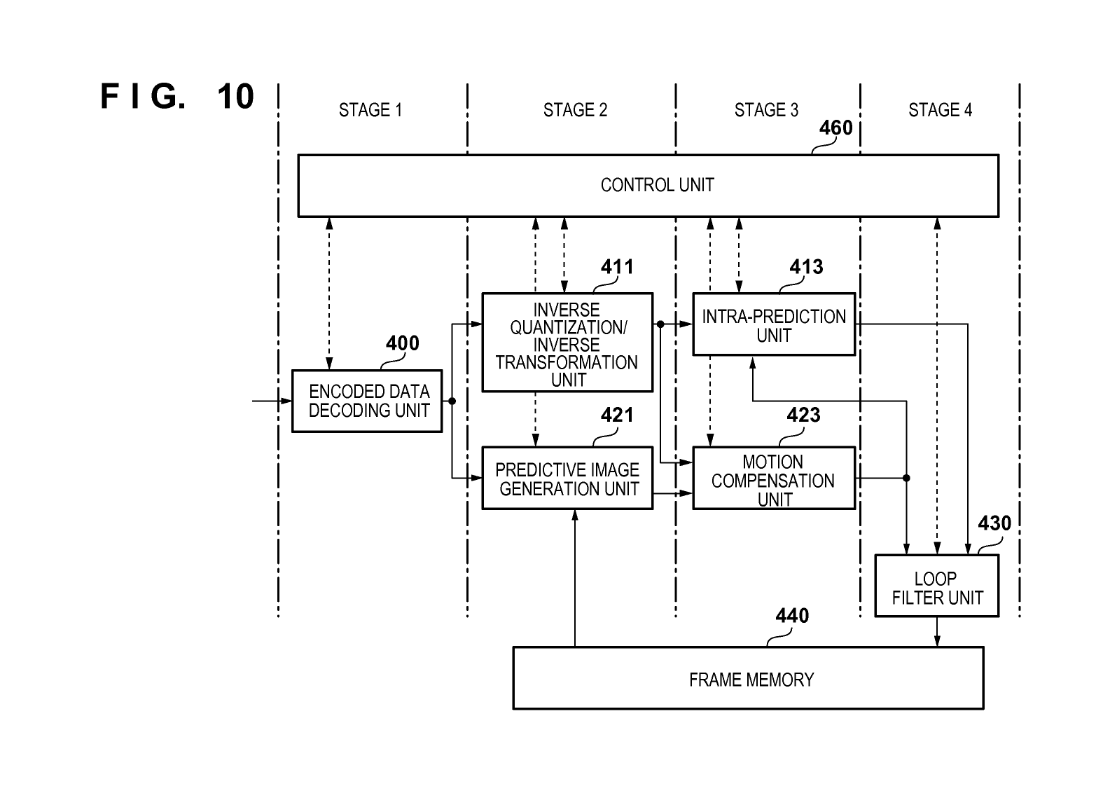

The respective units shown in FIGS. 1, 2, 4, 6, 8, and 10 may be formed from hardware. Alternatively, the control unit may be formed from a CPU, the processing unit functioning as a memory may be formed from a memory device such as a RAM or hard disk, and the remaining units may be formed from computer programs. In this case, the CPU can implement the functions of the respective units by executing the computer programs corresponding to these units.

### Other Embodiments

Aspects of the present invention can also be realized by a computer of a system or apparatus (or devices such as a CPU or MPU) that reads out and executes a program recorded on a memory device to perform the functions of the above-described embodiment(s), and by a method, the steps of which are performed by a computer of a system or apparatus by, for example, reading out and executing a program recorded on a memory device to perform the functions of the above-described embodiment(s). For this purpose, the program is provided to the computer for example via a network or from a recording medium of various types serving as the memory device (for example, computer-readable medium).

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2012-226331 filed Oct. 11, 2012 which is hereby incorporated by reference herein in its entirety.

What is claimed is:

1. An image processing apparatus which decodes each frame encoded for each block, comprising:
a decoding unit configured to decode encoded data of each block, thereby generating coefficient data and motion vector data of the block;
a unit configured to, every time said decoding unit generates coefficient data, generate predictive residual data from the coefficient data and store the predictive residual data in a predictive residual data memory capable of storing predictive residual data of at least two blocks;
a predictive image generation unit configured to, every time said decoding unit generates motion vector data, read out an image of an image region indicated by the motion vector data from a decoded frame memory which stores a decoded frame, and store the readout image as a predictive image in a predictive image memory capable of storing predictive images of at least two blocks; and
a motion compensation unit configured to, upon completion of storing predictive residual data and a predictive image of a block having undergone inter-frame coding in the predictive residual data memory and the predictive image memory respectively, decode the block by performing motion compensation using the predictive residual data and the predictive image, and store the decoded block in the decoded frame memory.

2. The apparatus according to claim 1, further comprising a unit configured to, upon completion of storing predictive residual data of a block having undergone intra-frame prediction coding in the predictive residual data memory, decode the block by using the predictive residual data, and store the decoded block in the decoded frame memory.

3. The apparatus according to claim 1, wherein said motion compensation unit performs deblocking filter processing for the decoded block, and stores the block having undergone the deblocking filter processing in the decoded frame memory.

4. An image processing apparatus which decodes each frame encoded for each block, comprising:
a decoding unit configured to decode encoded data of each block, thereby generating two-dimensional coefficient data and motion vector data of the block;
a unit configured to, every time said decoding unit generates two-dimensional coefficient data, perform first processing for the coefficient data as processing for each one-dimensional data string in one of a vertical direction and a horizontal direction, and store the coefficient data in a coefficient data memory capable of storing coefficient data of at least two blocks;
a predictive image generation unit configured to, every time said decoding unit generates motion vector data, read out an image of an image region indicated by the motion vector data from a decoded frame memory which stores a decoded frame, and store the readout image as a predictive image in a predictive image memory capable of storing predictive images of at least two blocks; and
a motion compensation unit configured to, upon completion of storing coefficient data of a block having undergone inter-frame coding in the coefficient data memory, generate predictive residual data by performing second processing for the coefficient data as processing for each one-dimensional data string in the other one of the vertical direction and the horizontal direction, decode the block by performing motion compensation using the predictive residual data and a predictive image of the block, and store the decoded block in the decoded frame memory.

5. An image processing method to be performed by an image processing apparatus which decodes each frame encoded for each block, comprising:
a decoding step of decoding encoded data of each block, thereby generating coefficient data and motion vector data of the block;
a step of, every time coefficient data is generated in the decoding step, generating predictive residual data from the coefficient data and storing the predictive residual data in a predictive residual data memory capable of storing predictive residual data of at least two blocks;
a predictive image generation step of, every time motion vector data is generated in the decoding step, reading out an image of an image region indicated by the motion vector data from a decoded frame memory which stores a decoded frame, and storing the readout image as a predictive image in a predictive image memory capable of storing predictive images of at least two blocks; and
a motion compensation step of, upon completion of storing predictive residual data and a predictive image of a block having undergone inter-frame coding in the predictive residual data memory and the predictive image memory respectively, decoding the block by performing motion compensation using the predictive residual data and the predictive image, and storing the decoded block in the decoded frame memory.

6. An image processing method to be performed by an image processing apparatus which decodes each frame encoded for each block, comprising:
a decoding step of decoding encoded data of each block, thereby generating two-dimensional coefficient data and motion vector data of the block;
a step of, every time two-dimensional coefficient data is generated in the decoding step, performing first processing for the coefficient data as processing for each one-dimensional data string in one of a vertical direction and a horizontal direction, and storing the coefficient data in a coefficient data memory capable of storing coefficient data of at least two blocks;
a predictive image generation step of, every time motion vector data is generated in the decoding step, reading out an image of an image region indicated by the motion vector data from a decoded frame memory which stores a decoded frame, and storing the readout image as a predictive image in a predictive image memory capable of storing predictive images of at least two blocks; and
a motion compensation step of, upon completion of storing coefficient data of a block having undergone inter-frame coding in the coefficient data memory, generating predictive residual data by performing second processing for the coefficient data as processing for each one-dimensional data string in the other one of the vertical direction and the horizontal direction, decoding the block by performing motion compensation using the predictive residual data and a predictive image of the block, and storing the decoded block in the decoded frame memory.

7. A non-transitory computer-readable storage medium storing a computer program for causing a computer to function as each unit of an image processing apparatus defined in claim 1.
